(19) United States
(12) Patent Application Publication
(10) Pub. No.: US 2018/0107510 A1
(43) Pub. Date: Apr. 19, 2018

(54) OPERATION OF A MULTI-SLICE PROCESSOR IMPLEMENTING INSTRUCTION FUSION

(71) Applicant: International Business Machines Corporation, Armonk, NY (US)

(72) Inventors: STEVEN R. CARLOUGH, POUGHKEEPSIE, NY (US); KURT A. FEISTE, AUSTIN, TX (US); DAVID R. TERRY, AUSTIN, TX (US); BRIAN W. THOMPTO, AUSTIN, TX (US); PHILLIP G. WILLIAMS, LEANDER, TX (US)

(21) Appl. No.: 15/297,669

(22) Filed: Oct. 19, 2016

(51) Int. Cl. G06F 9/48; G06F 9/52

(52) U.S. Cl. CPC G06F 9/4881; G06F 9/52

(57) ABSTRACT

Operation of a multi-slice processor implementing instruction fusion, where the multi-slice processor includes a plurality of execution slices. Operation of such a multi-slice processor includes: identifying, from a set of instructions, a first instruction that has an operand dependency on a second instruction in the set of instructions; and responsive to the first instruction having an operand dependency on the second instruction: issuing the first instruction and the second instruction to execute in parallel on the particular set of execution slices configured with fusion logic between execution slices that removes the operand dependency between the first instruction and the second instruction.

### BACKGROUND

### Field of the Invention

The field of the invention is data processing, or, more specifically, methods and apparatus for operation of a multi-slice processor.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One area of computer system technology that has advanced is computer processors. As the number of computer systems in data centers and the number of mobile computing devices has increased, the need for more efficient computer processors has also increased. Speed of operation and power consumption are just two areas of computer processor technology that affect efficiency of computer processors.

### SUMMARY

Methods and apparatus for operation of a multi-slice processor are disclosed in this specification. Such a multi-slice processor includes a plurality of execution slices and a plurality of load/store slices, where the load/store slices are coupled to the execution slices via a results bus. Operation of such a multi-slice processor includes: identifying, from a set of instructions, a first instruction that has an operand dependency on a second instruction in the set of instructions; and responsive to the first instruction having an operand dependency on the second instruction: issuing the first instruction and the second instruction to execute in parallel on the particular set of execution slices configured with fusion logic between execution slices that removes the operand dependency between the first instruction and the second instruction.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for operation of a multi-slice processor according to embodiments of the present invention.

FIG. 2 sets forth a block diagram of a portion of a multi-slice processor according to embodiments of the present invention.

FIG. 3 sets forth a block diagram of a dispatch network configured to implement instruction fusion according to different embodiments.

FIG. 4 sets forth a flow chart illustrating an exemplary method of operation of a multi-slice processor configured to implement instruction fusion according to different embodiments.

FIG. 5 sets forth a flow chart illustrating an exemplary method of operation of a multi-slice processor configured to implement instruction fusion according to different embodiments.

FIG. 6 sets forth a flow chart illustrating an exemplary method of operation of a multi-slice processor configured to implement instruction fusion according to different embodiments.

FIG. 7 sets forth a flow chart illustrating an exemplary method of operation of a multi-slice processor configured to implement instruction fusion according to different embodiments.

### DETAILED DESCRIPTION

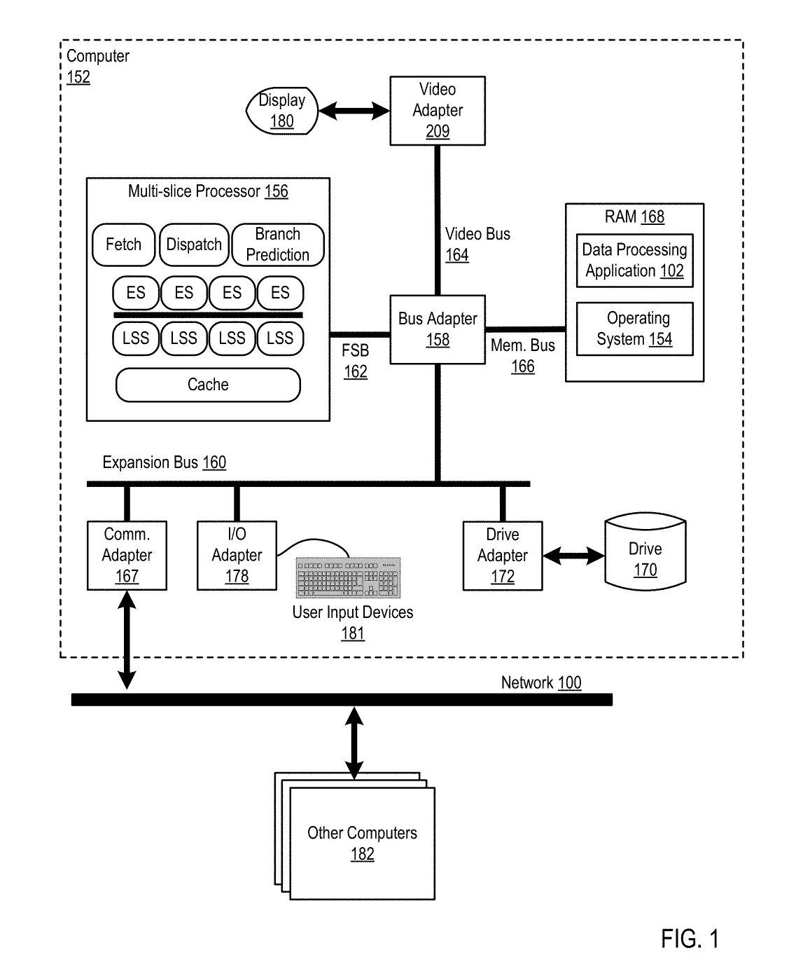

Exemplary methods and apparatus for operation of a multi-slice processor in accordance with the present invention are described with reference to the accompanying drawings, beginning with FIG. 1. FIG. 1 sets forth a block diagram of an example system configured for operation of a multi-slice processor according to embodiments of the present invention. The system of FIG. 1 includes an example of automated computing machinery in the form of a computer (152).

The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

The example computer processor (156) of FIG. 1 may be implemented as a multi-slice processor. The term ‘multi-slice’ as used in this specification refers to a processor having a plurality of similar or identical sets of components, where each set may operate independently of all the other sets or in concert with the one or more of the other sets. The multi-slice processor (156) of FIG. 1, for example, includes several execution slices (‘ES’) and several load/store slices (‘LSS’)—where load/store slices may generally be referred to as load/store units. Each execution slice may be configured to provide components that support execution of instructions: an issue queue, general purpose registers, a history buffer, an arithmetic logic unit (including a vector scalar unit, a floating point unit, and others), and the like. Each of the load/store slices may be configured with components that support data movement operations such as loading of data from cache or memory or storing data in cache or memory. In some embodiments, each of the load/store slices includes a data cache. The load/store slices are coupled to the execution slices through a results bus. In some embodiments, each execution slice may be associated with a single load/store slice to form a single processor slice. In some embodiments, multiple processor slices may be configured to operate together.

The example multi-slice processor (156) of FIG. 1 may also include, in addition to the execution and load/store slices, other processor components. In the system of FIG. 1, the multi-slice processor (156) includes fetch logic, dispatch logic, and branch prediction logic. Further, although in some embodiments each load/store slice includes cache memory, the multi-slice processor (156) may also include cache accessible by any or all of the processor slices.

Although the multi-slice processor (156) in the example of FIG. 1 is shown to be coupled to RAM (168) through a front side bus (162), a bus adapter (158) and a high speed memory bus (166), readers of skill in the art will recognize that such configuration is only an example implementation. In fact, the multi-slice processor (156) may be coupled to other components of a computer system in a variety of configurations. For example, the multi-slice processor (156) in some embodiments may include a memory controller configured for direct coupling to a memory bus (166). In some embodiments, the multi-slice processor (156) may support direct peripheral connections, such as PCIe connections and the like.

Stored in RAM (168) in the example computer (152) is a data processing application (102), a module of computer program instructions that when executed by the multi-slice processor (156) may provide any number of data processing tasks. Examples of such data processing applications may include a word processing application, a spreadsheet application, a database management application, a media library application, a web server application, and so on as will occur to readers of skill in the art. Also stored in RAM (168) is an operating system (154). Operating systems useful in computers configured for operation of a multi-slice processor according to embodiments of the present invention include UNIX™, Linux™, Microsoft Windows™, AIX™, IBM's z/OS™, and others as will occur to those of skill in the art. The operating system (154) and data processing application (102) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for operation of a multi-slice processor according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for operation of a multi-slice processor according to embodiments of the present invention include modems for wired dial-up communications, Ethernet (IEEE 802.3) adapters for wired data communications, and 802.11 adapters for wireless data communications.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

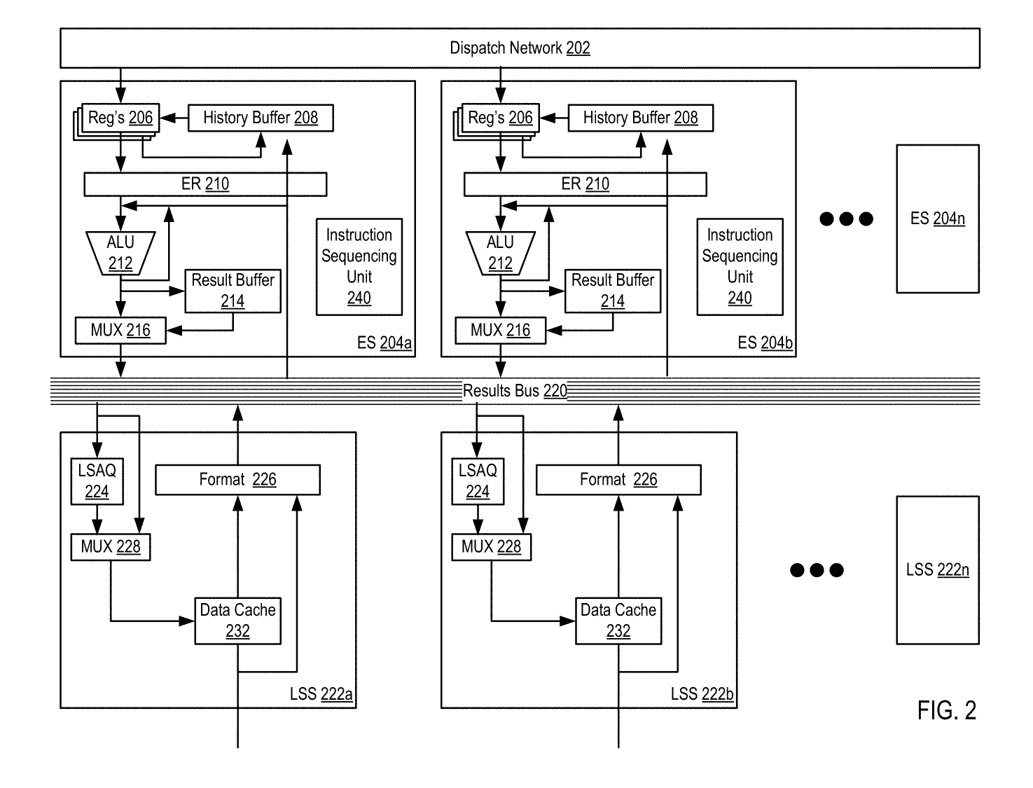

For further explanation, FIG. 2 sets forth a block diagram of a portion of a multi-slice processor according to embodiments of the present invention. The multi-slice processor in the example of FIG. 2 includes a dispatch network (202). The dispatch network (202) includes logic configured to dispatch instructions for execution among execution slices.

The multi-slice processor in the example of FIG. 2 also includes a number of execution slices (204a, 204b-204n). Each execution slice includes general purpose registers (206) and a history buffer (208). The general purpose registers and history buffer may sometimes be referred to as the mapping facility, as the registers are utilized for register renaming and support logical registers.

The general purpose registers (206) are configured to store the youngest instruction targeting a particular logical register and the result of the execution of the instruction. A logical register is an abstraction of a physical register that enables out-of-order execution of instructions that target the same physical register.

When a younger instruction targeting the same particular logical register is received, the entry in the general purpose register is moved to the history buffer, and the entry in the general purpose register is replaced by the younger instruction. The history buffer (208) may be configured to store many instructions targeting the same logical register. That is, the general purpose register is generally configured to store a single, youngest instruction for each logical register while the history buffer may store many, non-youngest instructions for each logical register.

Each execution slice (204) of the multi-slice processor of FIG. 2 also includes an execution reservation station (210). The execution reservation station (210) may be configured to issue instructions for execution. The execution reservation station (210) may include an issue queue. The issue queue may include an entry for each operand of an instruction. The execution reservation station may issue the operands for execution by an arithmetic logic unit or to a load/store slice (222a, 222b, 222c) via the results bus (220).

The arithmetic logic unit (212) depicted in the example of FIG. 2 may be composed of many components, such as add logic, multiply logic, floating point units, vector/scalar units, and so on. Once an arithmetic logic unit executes an operand, the result of the execution may be stored in the result buffer (214) or provided on the results bus (220) through a multiplexer (216).

The results bus (220) may be configured in a variety of manners and be of composed in a variety of sizes. In some instances, each execution slice may be configured to provide results on a single bus line of the results bus (220). In a similar manner, each load/store slice may be configured to provide results on a single bus line of the results bus (220). In such a configuration, a multi-slice processor with four processor slices may have a results bus with eight bus lines—four bus lines assigned to each of the four load/store slices and four bus lines assigned to each of the four execution slices. Each of the execution slices may be configured to snoop results on any of the bus lines of the results bus. In some embodiments, any instruction may be dispatched to a particular execution unit and then by issued to any other slice for performance. As such, any of the execution slices may be coupled to all of the bus lines to receive results from any other slice. Further, each load/store slice may be coupled to each bus line in order to receive an issue load/store instruction from any of the execution slices. Readers of skill in the art will recognize that many different configurations of the results bus may be implemented.

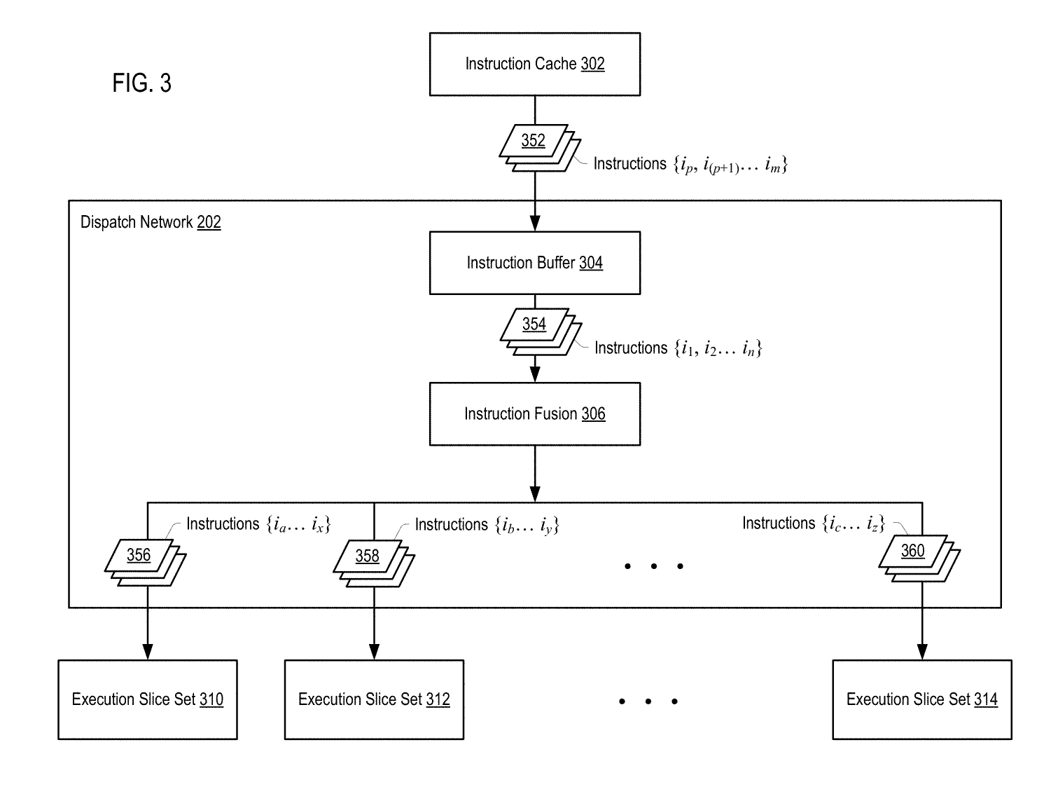

The multi-slice processor in the example of FIG. 2 also includes a number of load/store slices (222a, 222b-222n). Each load/store slice includes a queue (224), a multiplexer (228), a data cache (232), and formatting logic (226), among other components described below with regard to FIG. 3. The queue receives load and store operations to be carried out by the load/store slice (222). The formatting logic (226) formats data into a form that may be returned on the results bus (220) to an execution slice as a result of a load or store instruction.

The example multi-slice processor of FIG. 2 may be configured for flush and recovery operations. A flush and recovery operation is an operation in which the registers (general purpose register and history buffer) of the multi-slice processor are effectively ‘rolled back’ to a previous state. The term ‘restore’ and ‘recover’ may be used, as context requires in this specification, as synonyms. Flush and recovery operations may be carried out for many reasons, including missed branch predictions, exceptions, and the like. Consider, as an example of a typical flush and recovery operation, that a dispatcher of the multi-slice processor dispatches over time and in the following order: an instruction A targeting logical register 5, an instruction B targeting logical register 5, and an instruction C targeting logical register 5. At the time instruction A is dispatched, the instruction parameters are stored in the general purpose register entry for logical register 5. Then, when instruction B is dispatched, instruction A is evicted to the history buffer (all instruction parameters are copied to the history buffer, including the logical register and the identification of instruction B as the evictor of instruction A), and the parameters of instruction B are stored in the general purpose register entry for logical register 5. When instruction C is dispatched, instruction B is evicted to the history buffer and the parameters of instruction C are stored in the general purpose register entry for logical register 5. Consider, now, that a flush and recovery operation of the registers is issued in which the dispatch issues a flush identifier matching the identifier of instruction C. In such an example, flush and recovery includes discarding the parameters of instruction C in the general purpose register entry for logical register 5 and moving the parameters of instruction B from the history buffer for instruction B back into the entry of general purpose register for logical register 5.

During the flush and recovery operation, in prior art processors, the dispatcher was configured to halt dispatch of new instructions to an execution slice. Such instructions may be considered either target or source instructions. A target instruction is an instruction that targets a logical register for storage of result data. A source instruction by contrast has, as its source, a logical register. A target instruction, when executed, will result in data stored in an entry of a register file while a source instruction utilizes such data as a source for executing the instruction. A source instruction, while utilizing one logical register as its source, may also target another logical register for storage of the results of instruction. That is, with respect to one logical register, an instruction may be considered a source instruction and with respect to another logical register, the same instruction may be considered a target instruction.

The multi-slice processor in the example of FIG. 2 also includes an instruction sequencing unit (240). While depicted within individual execution slices, in some cases, the instruction sequencing unit may be implemented independently of the execution slices or implemented within dispatch network (202). Instruction sequencing unit (240) may take dispatched instructions and check dependencies of the instructions to determine whether all older instructions with respect to a current instruction have delivered, or may predictably soon deliver, results of these older instructions from which the current instruction is dependent so that the current instruction may execute correctly. If all dependencies to a current instruction are satisfied, then a current instruction may be determined to be ready to issue, and may consequently be issued—regardless of a program order of instructions, where a program order may be determined by an ITAG. Such issuance of instructions may be referred to as an “out-of-order” execution, and the multi-slice processor may be considered an out-of-order machine.

In some cases, a load/store unit receiving an issued instruction, such as a load/store slice, may not yet be able to handle the instruction, and the instruction sequencing unit (240) may keep the instruction queued until such time as the load/store slice may handle the instruction. After the instruction is issued, the instruction sequencing unit (240) may track progress of the instruction based at least in part on signals received from a load/store slice.

For further explanation, FIG. 3 sets forth a block diagram of a portion of the dispatch network (202) of the multi-slice processor (156) implementing instruction fusion. During normal operation, the dispatch network (202) receives computer instructions from an instruction cache (302) or other source, and dispatches the computer instructions among the various execution slices (204a, 204b-204n). Often, these computer instructions from the instruction cache (302) correspond to software written by a user and compiled for the multi-slice processor (156).

In this disclosure, the labels of a “first” instruction and a “second” instruction are merely for relative distinctions between program instructions with no implicit or explicit implication of an order in which the instructions are received or fetched and with no implicit or explicit implication of a program listing order. For instance, in the above example, where the first instruction is dependent upon a second instruction, the second instruction may an instruction that is ordered before the first instruction within the program listing of instructions of compiled source code. Further, one or more other instructions may be in between a first instruction and a second instruction.

In some cases, for a sequence of instructions in a reduced instruction set computer (RISC) architecture, patterns of instruction sequences appear that may be considered equivalent to a single instruction within a complex instructions set computer (CISC) architecture—where the sequence of instructions often includes a dependency between instructions. Further, a sequence of instructions may be identified where a first instruction uses information that may be shared with a second instruction such that a dependency between the first instruction and the second instruction is removed.

In response to identifying such a first instruction and second instruction, the multi-slice processor may “fuse” the first instruction and second instruction, where such an instruction fusion may include modifying the encoding of the first instruction so that an instruction sequencing unit may issue the first instruction and second instruction in parallel—where the instruction fusion may be performed during a stage of instruction processing in the dispatch network, and where the dispatch network may also provide a signal to the instruction sequencing unit that instructs the instruction sequencing unit to perform the first instruction and the second instruction in parallel.

Further, instruction fusion may include modifying the opcode of a dependent instruction of the one or more of the identified instructions such that the dependent instruction, when executed, includes—along with original functionality of the original, unmodified, instruction functionality of a previous instruction on which the dependent instruction is dependent. In this way, addition of functionality on which a dependent instruction is dependent, the dependent instruction may be executed in parallel with the instruction on which the unmodified instruction was dependent, where parallel execution is based at least in part on results of the functionality of the previous instruction being provided simultaneously, or substantially simultaneously, to both the previous instruction and the modified instruction identified as dependent upon the previous instruction.

Instruction fusion may further include the multi-slice processor issuing the first instruction and the second instruction to a particular set of execution slices from among the various execution slices (204a, 204b-204n) of the multi-slice processor—where the particular set of execution slices are configured with fusion logic that, when the first instruction and second instruction are executed in parallel, removes an operand dependency by routing an immediate result from the second instruction to the first instruction without the first instruction needing to wait to read the immediate result from a target register of the second instruction.

Since the result of an operation producing an immediate result may be provided—in dependence upon fusion logic between execution slices that are executing the fused instructions in parallel—to both the first instruction and the second instruction simultaneously, then dependencies based on reading that immediate result from a target register for the immediate result may be removed.

For example, a second instruction may be dependent upon a first instruction, where the second instruction operates on an operand that is an immediate value, and where the result of the operation of the second instruction is a simple operation, such as sign extension or a bit shift, and is stored in a target register that is a source register for the first instruction. In this way, for second instruction that includes an operation on an immediate value operand—which is to be performed regardless during performance of the second instruction—is routed directly to a first instruction and such that the simple operation is performed in the routing, that is dependent upon a result of the operation, instead of the first instruction being dependent upon reading the result of an operation from a target register of the second instruction storing a result of the operation, thereby eliminating an instruction dependency.

In another example the dependent operation may be defined by the Instruction Set Architecture to overwrite a source register where the program requires the source register to be preserved, so the program is written such that a first instruction moves the source operand to a new register and the second instruction uses the new location as its source register. In this example, fusion allows the second operation to use the original register of the first instruction while still writing the result to the second target location. In this way, the dependence between the instructions is removed and the instructions can issue in parallel.

In another example, the second operation may perform a simple operation on the result of the first operation, where that simple operation can be executed simultaneously by the execution hardware. In such an example, the Instruction Set Architecture may not contain the operation defined by the instruction pair. This may be common in Reduced Instruction Set computers. For example, an arithmetic operation for a first instruction may be followed by a sign extension of the result of the first instructions by a second instruction. In this case the fusion hardware can detect this combination of instructions and modify the internal opcode of the first instruction to also perform the sign extension of the result, allowing the second instruction to become a null, or no-operation (NOP), instruction and removing any dependencies between the instructions and removing the need to execute the second instruction in an execution unit.

In some cases, the removal of a dependency between instructions eliminates the usefulness or effect of at least one instruction, which may consequently be converted to a NOP instruction. Further, an instruction determined to be a null instruction may also be replaced by a different instruction stored in an instruction buffer. For example, a first instruction may be dependent upon a second instruction, where the second instruction operates on an immediate operand to generate a result that is stored in a target register, and where the target register is a source operand of the first instruction—in such an instance, the first instruction may be modified to incorporate the operation of the second instruction and the second instruction may be modified into a NOP instruction or replaced with another instruction.

Generally, the dispatch network (202) may receive a plurality of instructions, determine dependencies between the instructions, determine that at least some of the received instruction may be fused, fuse one or more instructions by modifying instruction opcodes, and direct fused instructions to a set of execution slices that are configured with fusion logic. In some cases, a set of execution slices may include two execution slices, such as execution slice (240a) and execution slice (240b)—where two execution slices may together be considered a “superslice.”

As depicted in FIG. 3, the dispatch network (202) may receive instructions (352), which includes the set of instructions {iₚ, i₍ₚ₊₁₎ . . . iₘ}, from the instruction cache (302). Received instructions may be stored within the instruction buffer (304). Previously received instructions, instructions (354), which include the set of instructions {i₁, i₂ . . . iₙ}, may be accessed from the instruction buffer (304).

Given a set of instructions, such as the set of instructions (354), the instruction fusion (306) logic may determine dependencies among the set of instructions (354) to generate one or more fused instructions, including instructions (356), (358), through (360). Further, a set, such as sets (356), (358), and (360), may include two or more instructions with more than one modification to fuse the instructions to remove dependencies between the instructions in the set.

In this example, the set of instructions (354) may be subdivided into sets, or subsets, (356), (358), and (360), where a union of the sets (356), (358), and (360) are equal to the set of instructions (354). As depicted in FIG. 3, set (356) includes instructions {iₐ . . . iₓ}, set (358) includes instructions {i_{b} . . . i_{y}}, and set (360) includes instructions {i_{c} . . . i_{z}}. However, in some cases, the set of instructions provided to a set of execution slices may include instructions from different sets of received instructions, such as instructions from instructions (354) and (352)—where a second instruction in the set of instructions provided to a set of execution slices is dependent on a first instruction in the set of instructions, and where the second instruction is from instructions (352) and the first instruction is from instructions (354).

Further, the set of instructions (356) may be directed toward, or issued to, the execution slice set (310), the set of instructions (358) may be directed toward, or issued to, the execution slice set (312), and the set of instructions (360) may be directed toward, or issued to, the execution slice set (314)—where a given execution slice set (310)-(314) may include multiple execution slices from among the execution slices of the multi-slice processor (156), and where each execution slice set (310)-(314) may be configured with fusion logic between execution slices of a particular execution slice set.

In this way, the dispatch network (202) may fuse instructions and issue sets of fused instructions to sets of execution slices such that a given set of execution slices receiving a given set of fused instructions may use fusion logic between the execution slices in the given set of execution slices to more efficiently execute a particular set of fused instructions.

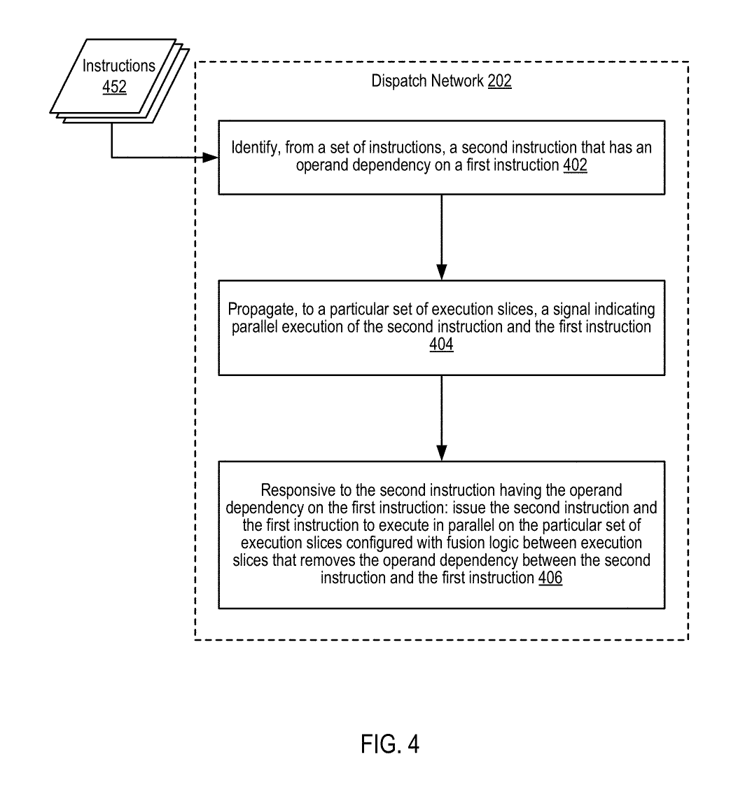

For further explanation, FIG. 4 sets forth a flow chart illustrating an exemplary method of instruction fusion. The method of FIG. 4 may be carried out by a multi-slice processor similar to that in the examples of FIGS. 1-3. Such a multi-slice processor may include a dispatch network (202) that includes instruction fusion (306) logic, as described above with regard to FIG. 3.

The method of FIG. 4 includes identifying (402), from a set of instructions (452), a first instruction that has an operand dependency on a second instruction. The set of instructions (452) may be received at an instruction buffer (304) from an instruction cache (302), as depicted in FIG. 3. Identifying (402) that the first instruction has an operand dependency upon the second instruction may be carried out by the instruction fusion (306) logic of the dispatch network (202) determining instructions to include in the set of instructions in dependence upon determining that a source operand for a first instruction is a source register, where the source register for the first instruction is a target register for a second instruction, and where the second instruction includes an operation on an immediate value.

For example, if the second instruction is an addition of an immediate value to a value stored in a register, say R2, and if the first instruction is a load operation that loads a value stored at an address equal to the immediate value result generated by the second instruction and stored in register R2, then the instruction fusion (306) logic may determine that the first instruction may be fused with the second instruction, where the fusion includes removing the dependency between the first instruction and the second instruction.

As another example, if the first instruction and second instruction are:

add R2, R1, D1

load R3, D2(R2)

where the “add” instruction is the second instruction, where the “load” instruction is the first instruction, where D1 is an immediate value that is added to the value stored in R1, where the sum of D1 and the value stored in RI is stored in target register R2, where D2 is an immediate value offset of the address stored in R2, where the data at the calculated address of “D2(R2)” is stored in target register R3, and where the first instruction is dependent upon a result of the second instruction operation on an immediate operand that is stored in target register R2. In this example, a result of the instruction fusion (306) logic may be:

add R2, R1, D1

load R3, (D1+D2)(R1)

where second instruction remains unchanged, and where the first instruction is modified to load from an address at R1 instead of R2, and where the address offset is modified to be equivalent to a value equal to a result of the second instruction, which in this case is (D1+D2). In other words, as a result of the modification or fusion, the source register of the first instruction, “load,” becomes the source register of the second instruction, “add,” and the immediate value offset of the first instruction becomes an equivalent expression to a result from performing the second instruction, which in this case is an addition. However, in general, the result from performing the second instruction may be any ALU operation, or any operation that generates an immediate value result. Further, since the first instruction and the second instruction are executed in parallel, the fusion logic may be configured to route a result of the second instruction simultaneously to both the first instruction and the second instruction. In this example, if the target register, R2, of the second instruction, “add,” were the same as the target register, R3, of the first instruction, “load,” then the instruction fusion (306) logic may modify the second instruction to be a NOP instruction or replace the second instruction with another instruction.

Similarly, for other sequences of instructions determined to be of a type that may be fused, the instruction fusion (306) logic may modify opcodes of one or more instructions to remove one or more dependencies between instructions to be fused—where removal of dependencies may include fusion logic of a set of execution slices routing immediate value calculations to more than one destination, one or more modifications of source registers for instructions, or a combination of these techniques.

In short, given an analysis of dependency between pairs of instructions received, the instruction fusion (306) logic may fuse instructions with at least one dependency between them such that the fused instructions, when provided to a particular set of execution slices, may execute the fused instructions in parallel.

The method of FIG. 4 also includes propagating (404), to a particular set of execution slices, a signal indicating parallel execution of the first instruction and the second instruction. Propagating (404) the signal may be carried out by the dispatch network (202) generating a signal, or providing information on a control line, that may be received and interpreted by an instruction sequencing unit of a particular set of execution slices as a command to execute the first instruction and the second instruction in parallel—where the dispatch network (202) may determine the particular set of execution slices to receive the first instruction and the second instruction based on the execution slices within the particular set of execution slices being configured with fusion logic, as described above with regard to FIG. 3. In other words, the dispatch network (202) may provide to the particular set of execution slices, along with the fused first and second instructions, a signal indicating that the instructions corresponding to the signal are to be executed in parallel as fused instructions. In other examples, instead of generating a signal to inform an instruction sequencing unit that a set of instructions are to be considered fused, and executed in parallel, the dispatch network (202) may specify tag bits in the opcode of the instructions that when decoded by the instruction sequencing unit, may indicate to the instruction sequencing unit that a particular instruction is to be executed with another instruction with a similar tag bit specification.

The instruction sequencing unit, responsive to receiving the fused first and second instructions, may issue the fused instructions for parallel execution on individual execution slices of the particular set of execution slices, such as a superslice, such that the fusion logic between the execution slices may overcome one or more dependency between the fused instructions. In other words, the fused first and second instructions in the set of instructions determined to include a dependency may be issued within a same cycle.

The method of FIG. 4 also includes, responsive to the first instruction having the operand dependency on the second instruction, issuing (406) the first instruction and the second instruction to execute in parallel on the particular set of execution slices configured with fusion logic between execution slices that removes the operand dependency between the first instruction and the second instruction.

Issuing (406) the first instruction and the second instruction to execute in parallel on the particular set of execution slices may be carried out by the dispatch network (202) sending each of the first instruction and the second instruction to an instruction sequencing unit or units for the same set of particular execution slices, such as a superslice. In other words, in this example, the first instruction and the second instruction do not go to different execution slices that are part of different sets of execution slices since such a distribution of issued instructions would be unable to make use of fusion logic.

Removing the operand dependency may be carried out as described above, where a modified first instruction may be provided with results directly from an execution unit of the execution slice simultaneously with the result being provided to the second instruction—where the result is generated according to the operation or operations specified in the second instruction. Further, as described above, the modified first instruction may have one or more source register operands replaced with one or more target registers of the second instruction.

In this way, the dispatch network (202) may issue instructions to sets of execution slices such that a given set of execution slices receiving a set of instructions may use fusion logic between the execution slices in the given set of execution slices to more efficiently execute the set of instructions.

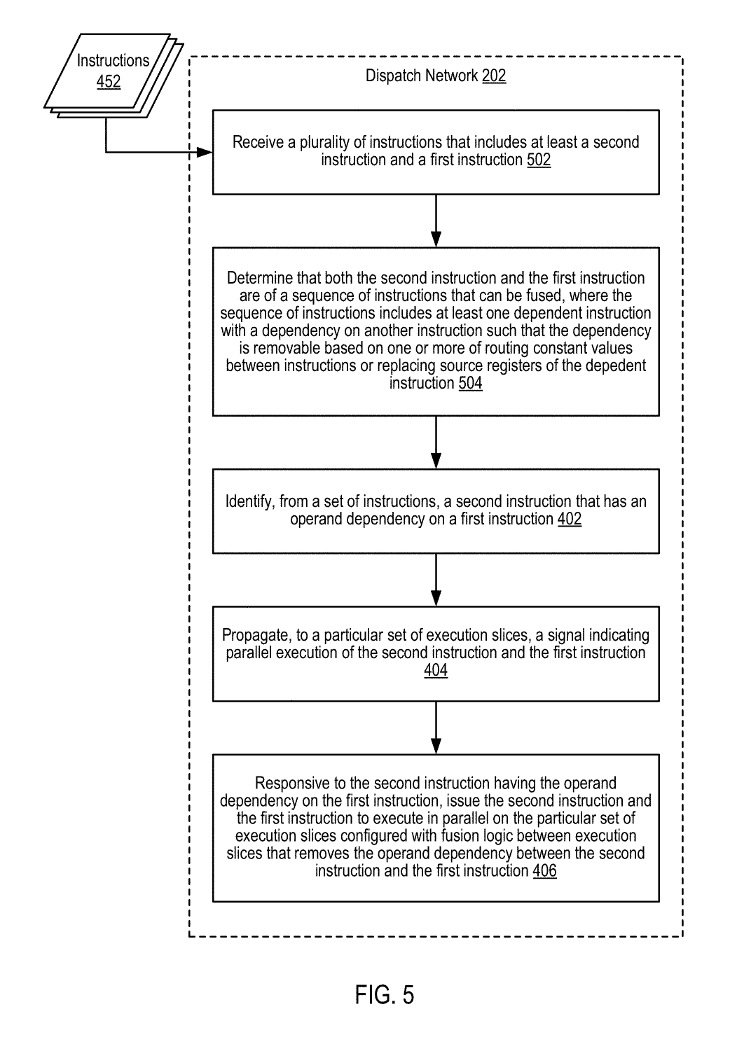

For further explanation, FIG. 5 sets forth a flow chart illustrating an exemplary method of operation of a multi-slice processor implementing instruction fusion. The method of FIG. 5 may be carried out by a multi-slice processor similar to that in the examples of FIGS. 1-3. Such a multi-slice processor may include a plurality of execution slices and a dispatch network, as described above with regard to FIGS. 1-3.

The method of FIG. 5 is similar to the method of FIG. 4 in that the method of FIG. 5 also includes: identifying (402), from a set of instructions (452), a first instruction that has an operand dependency on a second instruction; propagating (404), to a particular set of execution slices, a signal indicating parallel execution of the first instruction and the second instruction; and responsive to the first instruction having the operand dependency on the second instruction, issuing (406) the first instruction and the second instruction to execute in parallel on the particular set of execution slices configured with fusion logic between execution slices that removes the operand dependency between the first instruction and the second instruction.

The method of FIG. 5 differs from the method of FIG. 4, however, in that the method of FIG. 5 further includes, prior to identifying (404) that a first instruction has an operand dependency on a second instruction, receiving (502) a plurality of instructions that includes the first instruction and the second instruction; and determining (504) that both the first instruction and the second instruction are of a sequence of instructions that can be fused, where the sequence of instructions includes at least one dependent instruction with a dependency on another instruction such that the dependency is removable based on one or more of routing constant values between the instructions or replacing source registers of the dependent instruction.

Receiving (502) the plurality of instructions may be carried out by the dispatch network (202) receiving at an instruction buffer (304) instructions that are transmitted from an instruction cache, as depicted in FIG. 3.

Determining (504) that both the first instruction and the second instruction are of a sequence of instructions that can be fused may be carried out by the instruction fusion (306) logic identifying whether an instruction generates a constant, or immediate, value result, and stores the constant value result in a target register that is used as a source operand of a subsequent instruction.

In this way, the instruction fusion (306) logic may proceed to identify (402) the first instruction and the second instruction for instruction fusion.

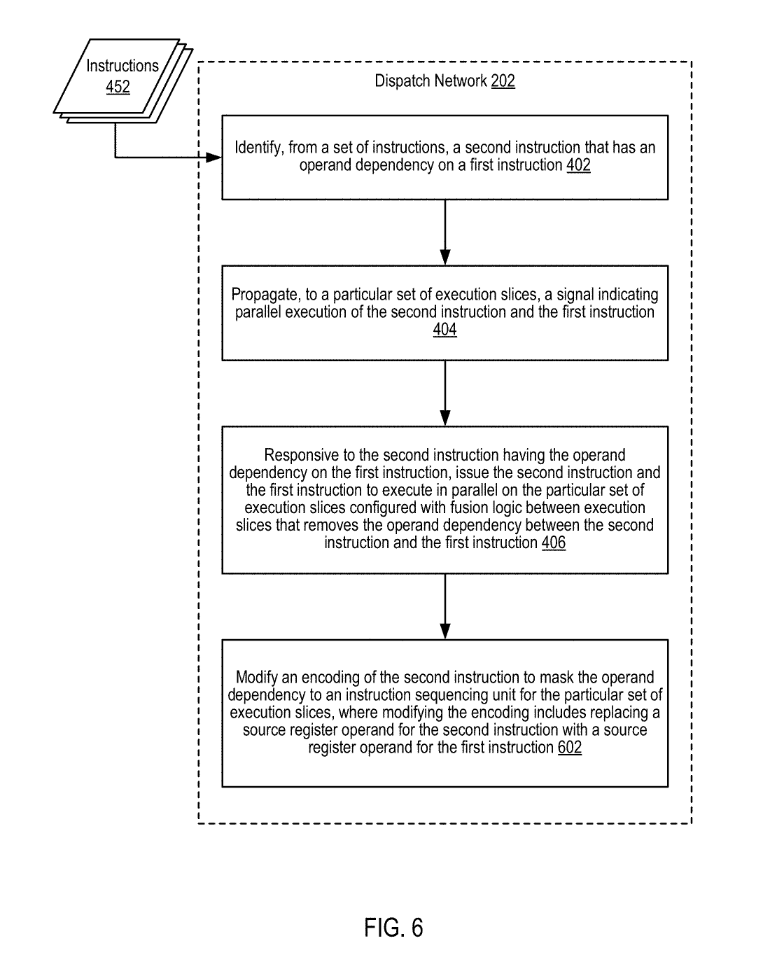

For further explanation, FIG. 6 sets forth a flow chart illustrating an exemplary method of operation of a multi-slice processor implementing instruction fusion. The method of FIG. 6 may be carried out by a multi-slice processor similar to that in the examples of FIGS. 1-3. Such a multi-slice processor may include a plurality of execution slices and a dispatch network, as described above with regard to FIGS. 1-3.

The method of FIG. 6 is similar to the method of FIG. 4 in that the method of FIG. 6 also includes: identifying (402), from a set of instructions (452), a first instruction that has an operand dependency on a second instruction; propagating (404), to a particular set of execution slices, a signal indicating parallel execution of the first instruction and the second instruction; and responsive to the first instruction having the operand dependency on the second instruction, issuing (406) the first instruction and the second instruction to execute in parallel on the particular set of execution slices configured with fusion logic between execution slices that removes the operand dependency between the first instruction and the second instruction.

The method of FIG. 6 differs from the method of FIG. 4, however, in that the method of FIG. 6 further includes: modifying (602) an encoding of the first instruction to mask the operand dependency to an instruction sequencing unit for the particular set of execution slices, where modifying the encoding includes replacing a source register operand for the first instruction with a source register operand for the second instruction.

Modifying (602) the encoding of the first instruction to mask the operand dependency may be carried out by the instruction fusion (306) logic replacing encoding bits of an opcode for the first instruction indicating an original source register operand with an encoding indicating a modified source register operand that is the same as a source register operand of the second instruction used in calculating an immediate value. Modifying (602) the encoding of the first instruction may be further carried out by the instruction fusion (306) logic modifying encoding of an operation performed to generate an immediate value in the first instruction to indicate an operation that is equivalent to performance of both the original operation of the first instruction and performance of the operation of the second instruction generating an immediate value that would have been used in an unmodified first instruction.

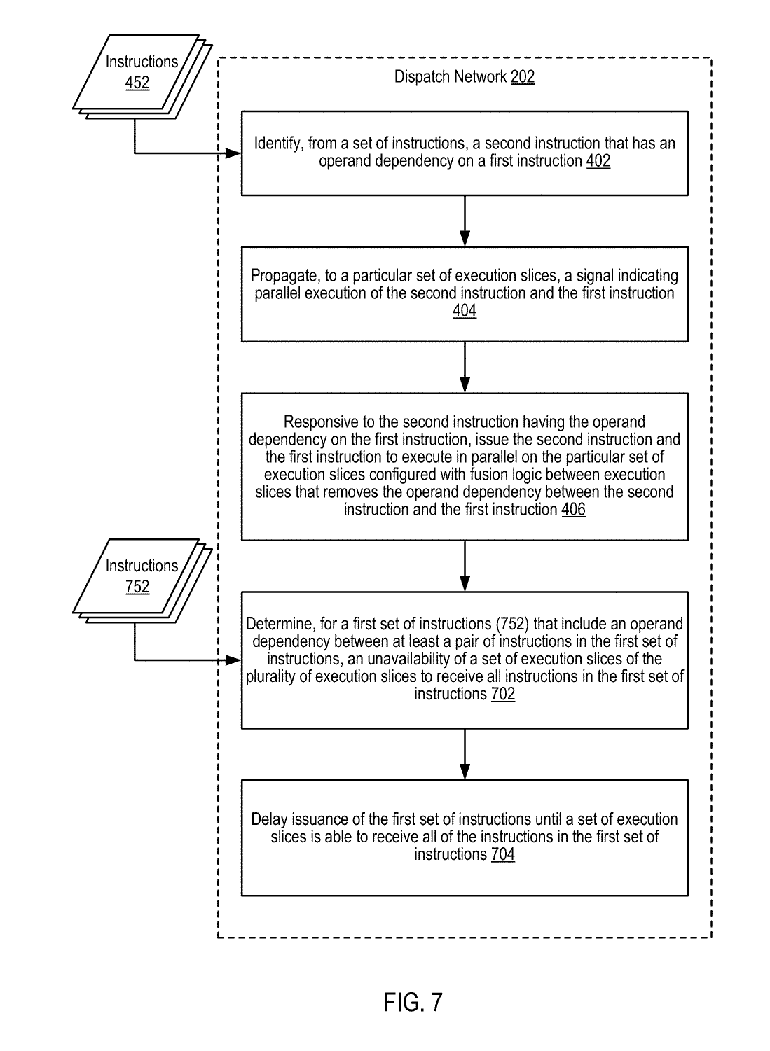

For further explanation, FIG. 7 sets forth a flow chart illustrating an exemplary method of operation of a multi-slice processor implementing instruction fusion. The method of FIG. 7 may be carried out by a multi-slice processor similar to that in the examples of FIGS. 1-3. Such a multi-slice processor may include a plurality of execution slices and a dispatch network, as described above with regard to FIGS. 1-3.

The method of FIG. 7 is similar to the method of FIG. 4 in that the method of FIG. 7 also includes: identifying (402), from a set of instructions (452), a first instruction that has an operand dependency on a second instruction; propagating (404), to a particular set of execution slices, a signal indicating parallel execution of the first instruction and the second instruction; and responsive to the first instruction having the operand dependency on the second instruction, issuing (406) the first instruction and the second instruction to execute in parallel on the particular set of execution slices configured with fusion logic between execution slices that removes the operand dependency between the first instruction and the second instruction.

The method of FIG. 7 differs from the method of FIG. 4, however, in that the method of FIG. 7 further includes: determining (702), for a second set of instructions (752) that include an operand dependency between at least a pair of instructions in the second set of instructions, an unavailability of a set of execution slices of the plurality of execution slices to receive all of the instructions in the second set of instructions; and delaying (704) issuance of the second set of instructions until a set of execution slices is able to receive all of the instructions in the second set of instructions.

Determining (702), for a second set of instructions (752) that include an operand dependency between at least a pair of instructions in the second set of instructions (752), an unavailability of a set of execution slices of the plurality of execution slices to receive all instructions in the second set of instructions may be carried out by the dispatch network (202) communicating with each of the sets of execution slices (310-314) to determine if a set of execution slices is able to handle, or receive, the quantity of instructions in the second set of instructions issue the set of instructions in parallel.

Delaying (704) issuance of the second set of instructions until a set of execution slices is able to receive all of the instructions in the second set of instructions may be carried out by the dispatch network (202), in dependence upon determining that a particular set of execution slices is able to handle, or receive, the quantity of instructions in the second set of instructions, maintaining the second set of instructions within the dispatch network (202) instead of issuing the second set of instructions.

The dispatch network (202) may periodically, or aperiodically, communicate with the sets of execution slices to determine whether all instructions in the second set of instructions may be issued to a single set of execution slices, and in response, the dispatch network (202) may issue all of the instructions to the single set of execution slices.

While the second set of instructions may be delayed from issuing, other instructions may continue to be issued, generally, the reduction in execution latencies from the instructions being sent together to a same set of execution slices to use bypass logic within the set of execution slices is greater than cycles that may be spent delaying the issuance of the second set of instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of operation of a multi-slice processor, the multi-slice processor including a plurality of execution slices, wherein the method comprises:
identifying, from a set of instructions, a first instruction that has an operand dependency on a second instruction in the set of instructions; and
responsive to the first instruction having an operand dependency on the second instruction:
issuing the first instruction and the second instruction to execute in parallel on the particular set of execution slices configured with fusion logic between execution slices that removes the operand dependency between the first instruction and the second instruction.

2. The method of claim 1, further comprising:
determining that both the first instruction and the second instruction are of a sequence of instructions that can be fused, wherein the sequence of instructions includes at least one dependent instruction with a dependency on another instruction such that the dependency is removable based on one or more of: routing constant values between the instructions or replacing source registers of the dependent instruction.

3. The method of claim 1, further comprising:
modifying an encoding of the first instruction to mask the operand dependency to an instruction sequencing unit for the particular set of execution slices, wherein modifying the encoding comprises replacing a source register operand for the first instruction with a source register operand for the second instruction.

4. The method of claim 1, further comprising:
propagating, to the particular set of execution slices, a signal indicating parallel execution of the first instruction and the second instruction, wherein propagating the signal to the particular set of execution slices comprises propagating the signal to an instruction sequencing unit that schedules execution of instructions for the particular set of execution slices.

5. The method of claim 4, wherein the fusion logic between the execution slices of the particular set of execution slices is configured to route, during parallel execution of the first instruction and the second instruction, an operand for the second instruction to the first instruction to remove the operand dependency between the first instruction and the second instruction.

6. The method of claim 1, further comprising:
determining that a target of the first instruction is a same target register as a target of the second instruction, wherein the second instruction operates on an immediate operand to generate a result that is stored in the target register, and where the target register is a source operand of the first instruction;
modifying the first instruction to incorporate the second instruction; and
converting the second instruction into a null operation.

7. The method of claim 1, further comprising:
determining that the second instruction is a sign extension of the first instruction; and modifying the first instruction to perform the sign extension.

8. A multi-slice processor comprising:
a plurality of execution slices, wherein the multi-slice processor is configured to carry out:
identifying, from a set of instructions, a first instruction that has an operand dependency on a second instruction in the set of instructions; and
responsive to the first instruction having an operand dependency on the second instruction:
issuing the first instruction and the second instruction to execute in parallel on the particular set of execution slices configured with fusion logic between execution slices that removes the operand dependency between the first instruction and the second instruction.

9. The multi-slice processor of claim 8, wherein the multi-slice processor is further configured to carry out:
determining that both the first instruction and the second instruction are of a sequence of instructions that can be fused, wherein the sequence of instructions includes at least one dependent instruction with a dependency on another instruction such that the dependency is removable based on one or more of: routing constant values between the instructions or replacing source registers of the dependent instruction.

10. The multi-slice processor of claim 8, wherein the multi-slice processor is further configured to carry out:
modifying an encoding of the first instruction to mask the operand dependency to an instruction sequencing unit for the particular set of execution slices, wherein modifying the encoding comprises replacing a source register operand for the first instruction with a source register operand for the second instruction.

11. The multi-slice processor of claim 8, wherein the multi-slice processor is further configured to carry out:
propagating, to the particular set of execution slices, a signal indicating parallel execution of the first instruction and the second instruction, wherein propagating the signal to the particular set of execution slices comprises propagating the signal to an instruction sequencing unit that schedules execution of instructions for the particular set of execution slices.

12. The multi-slice processor of claim 11, wherein the fusion logic between the execution slices of the particular set of execution slices is configured to route, during parallel execution of the first instruction and the second instruction, an operand for the second instruction to the first instruction to remove the operand dependency between the first instruction and the second instruction.

13. The multi-slice processor of claim 8, wherein the multi-slice processor is further configured to carry out:
determining that a target of the first instruction is a same target register as a target of the second instruction, wherein the second instruction operates on an immediate operand to generate a result that is stored in the target register, and where the target register is a source operand of the first instruction;
modifying the first instruction to incorporate the second instruction; and
converting the second instruction into a null operation.

14. The multi-slice processor of claim 8, wherein the multi-slice processor is further configured to carry out:
determining that the second instruction is a sign extension of the first instruction; and
modifying the first instruction to perform the sign extension.

15. An apparatus comprising:
a plurality of execution slices, wherein the multi-slice processor is configured to carry out:
identifying, from a set of instructions, a first instruction that has an operand dependency on a second instruction in the set of instructions; and
responsive to the first instruction having an operand dependency on the second instruction:
issuing the first instruction and the second instruction to execute in parallel on the particular set of execution slices configured with fusion logic between execution slices that removes the operand dependency between the first instruction and the second instruction.

16. The apparatus of claim 15, wherein the multi-slice processor is further configured to carry out:
determining that both the first instruction and the second instruction are of a sequence of instructions that can be fused, wherein the sequence of instructions includes at least one dependent instruction with a dependency on another instruction such that the dependency is removable based on one or more of: routing constant values between the instructions or replacing source registers of the dependent instruction.

17. The apparatus of claim 15, wherein the multi-slice processor is further configured to carry out:
modifying an encoding of the first instruction to mask the operand dependency to an instruction sequencing unit for the particular set of execution slices, wherein modifying the encoding comprises replacing a source register operand for the first instruction with a source register operand for the second instruction.

18. The apparatus of claim 15, wherein the multi-slice processor is further configured to carry out:
propagating, to the particular set of execution slices, a signal indicating parallel execution of the first instruction and the second instruction, wherein propagating the signal to the particular set of execution slices comprises propagating the signal to an instruction sequencing unit that schedules execution of instructions for the particular set of execution slices.

19. The apparatus of claim 18, wherein the fusion logic between the execution slices of the particular set of execution slices is configured to route, during parallel execution of the first instruction and the second instruction, an operand for the second instruction to the first instruction to remove the operand dependency between the first instruction and the second instruction.

20. The apparatus of claim 15, wherein the multi-slice processor is further configured to carry out:
determining that a target of the first instruction is a same target register as a target of the second instruction, wherein the second instruction operates on an immediate operand to generate a result that is stored in the target register, and where the target register is a source operand of the first instruction;
modifying the first instruction to incorporate the second instruction; and
converting the second instruction into a null operation.
